(19) United States
(12) Patent Application Publication
(10) Pub. No.: US 2017/0091693 A1
(43) Pub. Date: Mar. 30, 2017

(54) TEAM PERFORMANCE BY REFINING TEAM STRUCTURE

(71) Applicant: International Business Machines Corporation, Armonk, NY (US)

(72) Inventors: Nan Cao, Ossining, NY (US); Ching-Yung Lin, Scarsdale, NY (US); David M. Lubensky, Brookfield, CT (US); Hanghang Tong, Chandler, AZ (US)

(21) Appl. No.: 14/870,077

(22) Filed: Sep. 30, 2015

(51) Int. Cl. G06Q 10/06; G06F 3/0484; G06F 17/30

(52) U.S. Cl. CPC G06Q 10/063112; G06F 17/30867; G06F 17/30554; G06F 3/0484

(57) ABSTRACT

A method for improving team performance by refining team structure includes selecting a team of interest comprising a plurality of individuals, visualizing the team of interest using a graph depicting each individual's skills relevant to a task, refining the team of interest based on the visualization, and displaying the refined team of interest. The method of claim 1, wherein refining the team of interest comprises shrinking the team of interest by removing a member. The method may further comprise calculating a shrinkage score for each member of the team of interest, wherein a shrinkage score is representative of the negative effects of removing a team member from the team. The method may additionally include removing the team member with the smallest shrinkage score from the team of interest. A computer program product and computer system corresponding to the method are also disclosed.

### STATEMENT REGARDING FEDERALLY SPONSORED WORK

This invention was made with United States Government support under contract number: W911NF-12-C-0028 entered with the following United States Governmental Agency: Defense Advanced Research Projects Agency (DARPA). The United States government has certain rights to this invention.

### BACKGROUND OF THE INVENTION

The present invention relates generally to the field of team refinement, and more specifically to refining a team configuration to improve its performance.

Many businesses rely on groups or teams of employees assigned to complete a variety of tasks corresponding to projects within the business. These teams may be made up of members with similar skillsets and knowledge bases who are best suited to address a particular topic. Teams may also consist of members with very different skillsets, with each member assigned a different aspect of a task or project to complete or monitor. An important element of a team's performance may be how well suited each individual is for the position he or she holds.

### SUMMARY

As disclosed herein, a method for improving team performance by refining team structure includes selecting a team of interest comprising a plurality of individuals, visualizing the team of interest using a graph depicting each individual's skills relevant to a task, refining the team of interest based on the visualization, and displaying the refined team of interest. The method of claim 1, wherein refining the team of interest comprises shrinking the team of interest by removing a member. The method may further comprise calculating a shrinkage score for each member of the team of interest, wherein a shrinkage score is representative of the negative effects of removing a team member from the team. The method may additionally include removing the team member with the smallest shrinkage score from the team of interest. The method may further comprise creating a graph of the current members of the team of interest depicting each individual's skills relevant to the team of interest, refining the team of interest based on the created graph, and creating a graph of the refined team. The method may further comprise computing a graph kernel between the graph of the current members of the team of interest and the graph of the refined team. A computer program product and computer system corresponding to the method are also disclosed.

### BRIEF DESCRIPTION OF THE DRAWINGS

FIG. 1 is a block diagram depicting one embodiment of a team refinement system in accordance with some embodiments of the present invention;

FIG. 2 is a flowchart depicting one embodiment of a team refinement method in accordance with one embodiment of the present invention;

FIG. 3 depicts an example of a skillset visualization interface in accordance with some embodiments of the present invention; and

FIG. 4 depicts a block diagram of components of a computer, in accordance with some embodiments of the present invention.

### DETAILED DESCRIPTION

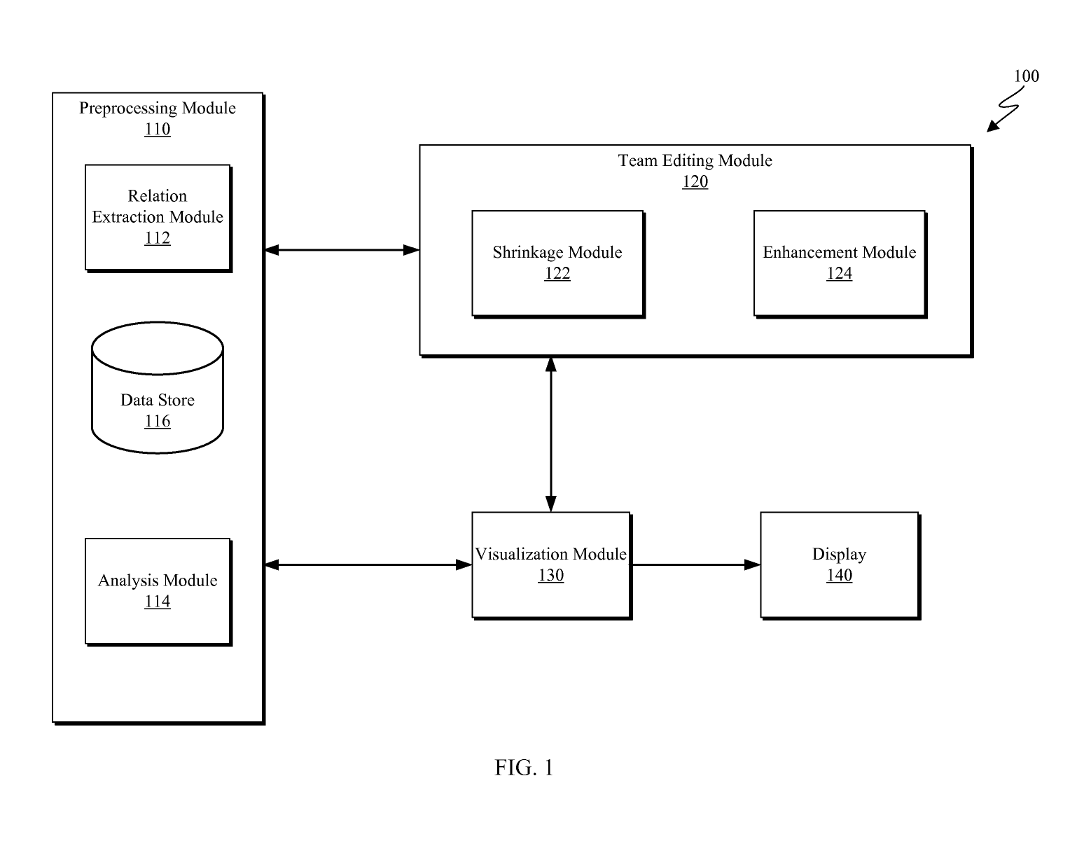

FIG. 1 is a block diagram depicting one embodiment of a team refinement system 100 in accordance with some embodiments of the present invention. As depicted, team refinement system 100 includes a preprocessing module 110, a team editing module 120, and a visualization module 130. Team refinement system 100 may be used to refine a team structure in the context of a social network to improve its performance.

As depicted, preprocessing module 110 includes relation extraction module 112, analysis module 114, and data store 116. Relation extraction module 112 may be configured to receive team information corresponding to a network of individuals. Relation extraction module 112 receives information indicating which individuals are on each team. In some embodiments, relation extraction module 112 is additionally configured to analyze communications between individuals. In particular, relation extraction module 112 may analyze how frequently team members communicate with one another via email, phone call, or additional messaging services.

Analysis module 114 may be configured to receive information from relation extraction module 112 indicating which individuals are on each team. In some embodiments, analysis module 114 additional receives communication information indicating how frequently team members communicate with one another. Analysis module 114 may be configured to analyze a set of skills relevant to an individual's ability to be an effective team member. In some embodiments, analysis module 114 creates a graph corresponding to an individual's relevant skillset.

Data store 116 may be configured to store team information, as well as any information or data produced by other modules within team refinement system 100.

As depicted, team editing module 120 includes shrinkage module 122 and enhancement module 124. Shrinkage module 122 may be configured to receive team information and skillset information. Shrinkage module 122 may be configured to calculate a shrinkage score for each member of a team. The shrinkage score for an individual is a numerical representation of the negative impact removing said individual from the team would have. In some embodiments where someone must be removed from a team, calculating the shrinkage score enables removing the individual whose loss would be the least detrimental. Shrinkage module 122 may be configured to provide all relevant shrinkage scores.

Enhancement module 124 may be configured to receive team information and skillset information. Based on the received team information and skillset information, enhancement module 124 may additionally be configured to determine if an additional team member should be added to the existing team. For example, enhancement module 124 may determine that a particular team is lacking an individual to oversee the financial aspects of a project the team has been assigned. Enhancement module 124 may then identify an individual from the network who has an extensive knowledge base in the financial aspects of said project and recommend that the identified individual be added to the team. In some embodiments, enhancement module 124 will only seek and recommend individuals who are not members of other teams. Enhancement module 124 may additionally be configured to recommend enhancing an individual's knowledge base in a certain field. For example, in the embodiment where enhancement module 124 determines a particular team is lacking financial knowledge, enhancement module 124 may recommend that an individual be educated in the relevant financial field. The selected individual may be someone who has a minimal background in the field already.

Visualization module 130 may be configured to receive recommended team refinements from team editing module 120 along with original team information from preprocessing module 110. In some embodiments, visualization module 130 creates a graph depicting the skillsets of the team members of the original team along with a graph depicting the skillsets of the team members of the proposed refined team. Visualization module 130 may additionally be configured to calculate the graph kernel between these two graphs to highlight the similarities and differences between the two. A graph kernel is a kernel function that computes an inner product on graphs. In one embodiment, the kernel may be calculated using a random walk kernel, which conceptually performs random walks on two graphs simultaneously and then tallies the number of paths that were produced by both walks. Visualization module 130 may be configured to provide graphs it produces to display 140 to be viewed by a user. Display 140 may provide a mechanism to display data to a user and may be, for example, a computer monitor.

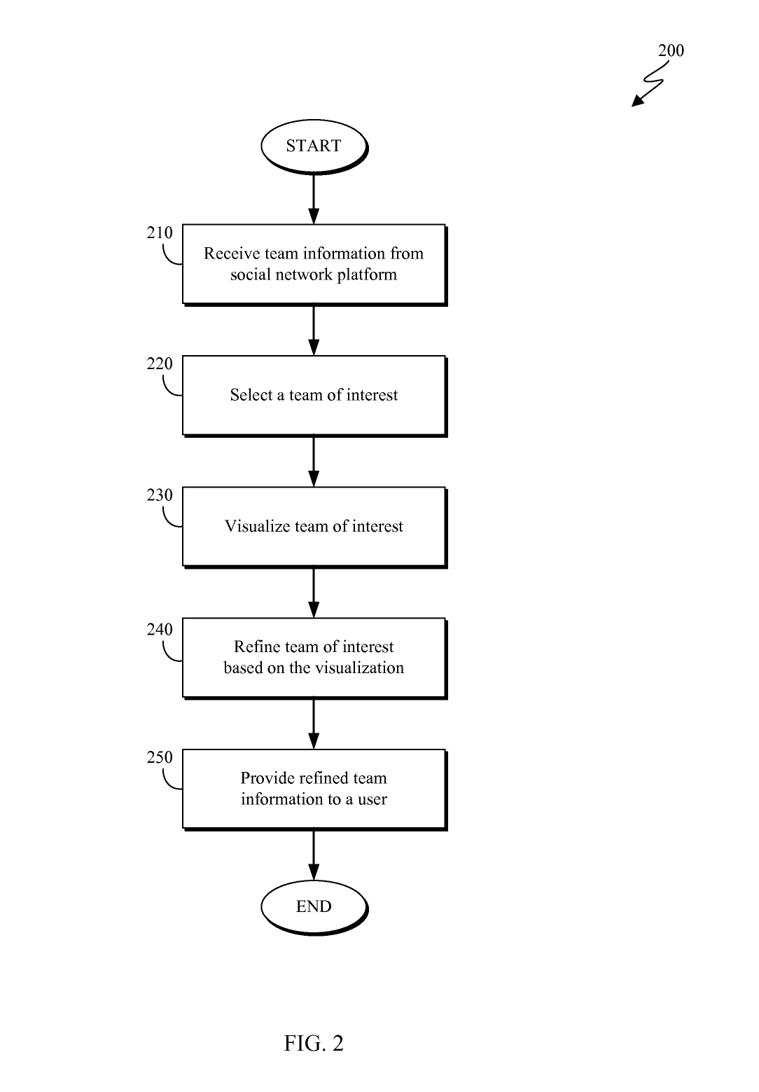

FIG. 2 is a flowchart depicting one embodiment of a team refinement method 200 in accordance with one embodiment of the present invention. As depicted, team refinement method 200 includes receiving (210) team information from a social network platform, selecting (220) a team of interest, visualizing (230) the team of interest, refining (240) the team of interest based on the visualization, and providing (250) refined team information to a user. Team refinement method 200 may be used to refine a team structure in the context of a social network to improve its performance.

Receiving (210) team information from a social network platform may include receiving a set of team information indicating a plurality of individuals who are members of one or more teams within a network. In one embodiment, the set of team information includes a list of individuals within the network and an indication of which team or teams each individual is associated with. The team information may also include communication information indicating how frequently individuals communicate with one another. In one embodiment, the communication information is based on how frequently individuals email or call one another. In some embodiments, all individuals within the network are included in the team information, even those who are not associated with any teams. In another embodiment, only individuals who are associated with teams are included in the team information.

Selecting (220) a team of interest may include selecting a team to be refined. In one embodiment, selecting (220) a team of interest comprises enabling a user to select a team of interest via a graphical user interface. In some embodiments, where team performance information is available, selecting (220) a team of interest may be an automated process in which the team exhibiting the poorest performance is selected to be refined.

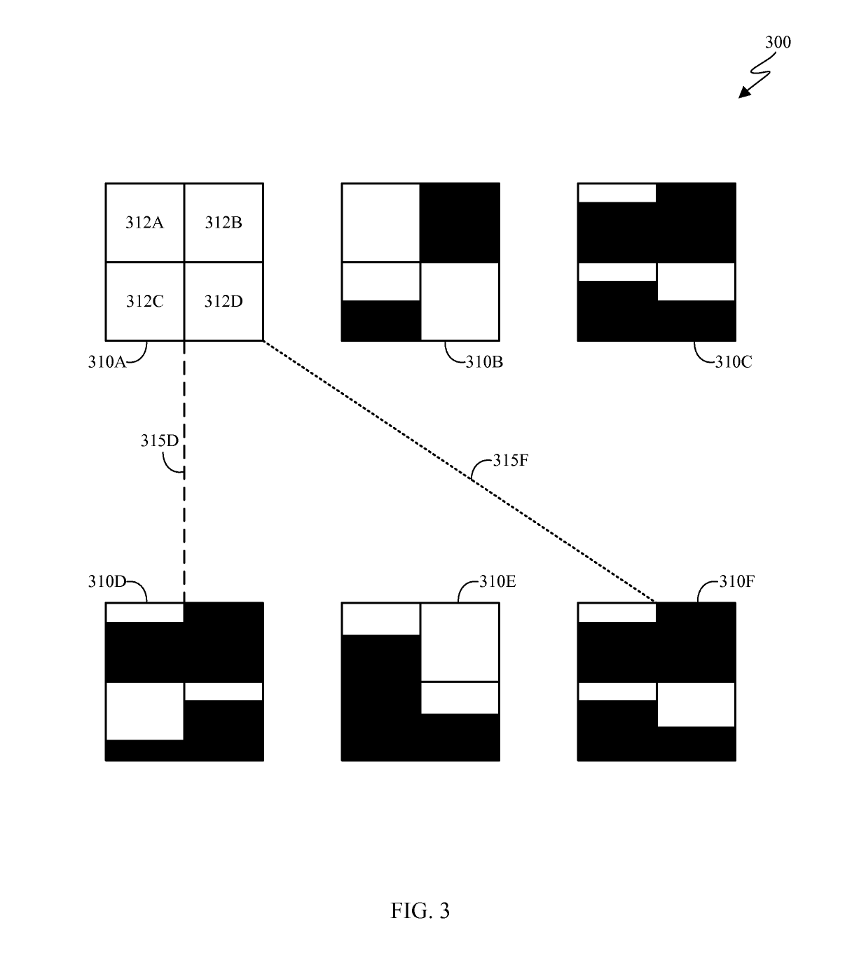

Visualizing (230) the team of interest may include displaying the team of interest as it currently exists. In one embodiment, each individual on the team is displayed with a graphical depiction of his/her attributes that are relevant to the performance of the team. In one embodiment, the graphical depiction may correspond to a predetermined set of skills, attributes, or knowledge areas that are related to team performance. For example, for a project related to computer programming where individuals will have to work closely in teams, the graphical depiction may include a representation of how fluent an individual is in a number of relevant programming languages, as well as a depiction of how well an individual performs when working within a team. An example of a visualization of a team is discussed with respect to FIG. 3.

Refining (240) the team of interest based on the visualization may include editing the existing team based on the visualization to improve the team's potential performance. In one embodiment, refining (240) the team of interest may include shrinking the team by removing a member. In another embodiment, refining the team may include expanding the team by adding an additional member from the network who is deemed a good fit for the team according to the visualization. In yet another embodiment, refining the team includes recommending improved communication between two team members. For example, the visualization of a team may reveal that the members of the team are already optimized, but communication between two key members of the team is lacking. A recommendation will then be made for enhanced communication between these members to improve performance.

Providing (250) refined team information to a user may include displaying suggested modifications to the existing team to a user. In some embodiments, the refined team information is displayed in a manner that indicates the previous team, the action to be taken, and the resulting team. For example, if the team refinement calls for the replacement of an individual named “Kevin” with an individual named “Jay”, the display of the refined team information would include the original team with “Kevin”, the new team without “Kevin” and with “Jay” instead, and an instruction indicating that the action that needs to be taken is to replace “Kevin” with “Jay”. In one embodiment, the refined team information is displayed to a user via a display such as the one discussed with respect to FIG. 1.

FIG. 3 depicts an example of a skillset visualization interface 300 in accordance with some embodiments of the present invention. As depicted, skillset visualization interface 300 includes nodes 310A, 310B, 310C, 310D, 310E, and 310F, communication strengths 315D and 315F, and cells 312A, 312B, 312C, and 312D. Skillset visualization interface 300 is just one example of a form of depicting the skills of one or more individuals.

Nodes 310A, 310B, 310C, 310D, 310E, and 310F each correspond to a unique individual from within a network. In one embodiment, each node corresponds to a different team member. In another embodiment, some of the nodes may correspond to current members of a team of interest, and others may correspond to other individuals within a network who could be potential candidates to join the team. As depicted, each node is split into four cells (labeled 312A, 312B, 312C, and 312D with respect to node 310A). Each cell corresponds to a certain skill or knowledge area of interest. For example, cell 312A may correspond to familiarity with a specific computer programming language, cell 312B may correspond to a certification necessary to work on a project, cell 312C may correspond to an ability to meet deadlines based on previous projects, and cell 312D may correspond to familiarity with a database relevant to a project of interest. In the depicted embodiment, a percentage of each cell is filled in black to reflect an individual's proficiency in each skill or knowledge area. For example, with respect to node 310C, cell 312A is roughly 80% filled, indicating that the corresponding individual's proficiency with the relevant computer programming language rated at 80% on an appropriate scale. Similarly, cell 312C is also roughly 80% filled, meaning the corresponding individual has shown the ability to meet deadlines roughly 80% of the time. This measurement may be a raw percentage of projects the individual worked on that were completed on time. Cell 312D is less than 50% filled, indicating that the user's familiarity with the relevant database rated below 50% on an appropriate scale. Cell 312B is entirely filled, indicating that the corresponding individual has the necessary certification to work on the relevant project. Since an individual either does or does not have the certification, cell 312B can only be entirely black or entirely white in this embodiment.

With respect to the depicted embodiment, comparing individuals can be conducted in a number of ways. The depicted visualization may enable a user to easily view and compare individuals manually. Since cells 312A, 312C, and 312D correspond to a skill or knowledge base for which some kind of score has been calculated, a raw comparison of these scores can easily be calculated as well. The comparison of two users with respect to the depicted embodiment can be tailored as well. In one embodiment, each skill may be considered equally valuable, and an individual with the least white space (i.e. the individual who scored the highest with respect to all the relevant skills) may be considered the most valuable. In other embodiments, the skills may be attributed different weights. For example, it may be determined that a user can be brought up to speed on database concepts much more easily than the relevant computer programming language. The computer programming language proficiency score may then be given twice the weight of the database proficiency score, so a 20% difference between two individuals' database familiarity scores is offset by a 10% difference in the computer programming language proficiency scores.

With respect to the depicted embodiment, a node may be compared to another node by calculating a difference between each skillset measurement and taking into account any attributed weights. The differences in each respective skillset may be aggregated into one metric indicating which individual may be best suited overall to be a member of the team of interest. In other embodiments, a user may decide that a team needs improvement in a specific skill area, and may be interested in replacing a member to improve said skill area with minimal detriment in other skill areas. In these embodiments, individuals may be compared with respect to the skill area of interest and with respect to all other skill areas considered together. For example, when comparing two individuals, the difference in the proficiency in the skill area of interest may be weighed against the cumulative difference in all other skillset areas.

Communication strengths 315D and 315F may correspond to how frequently individuals within a network communicate. In the depicted embodiment, communication strength 315D corresponds to how frequently the individual to whom node 310A corresponds and the individual to whom node 310D corresponds communicate. In the depicted embodiment, communication strength 315F is stronger than communication strength 315D, as indicated by a less sparsely dashed line. The communication strength between two individuals may correspond to how frequently they communicate via email, phone, or internal messaging system. Nodes with no communication strength depicted between them correspond to individuals who have no regular communication.

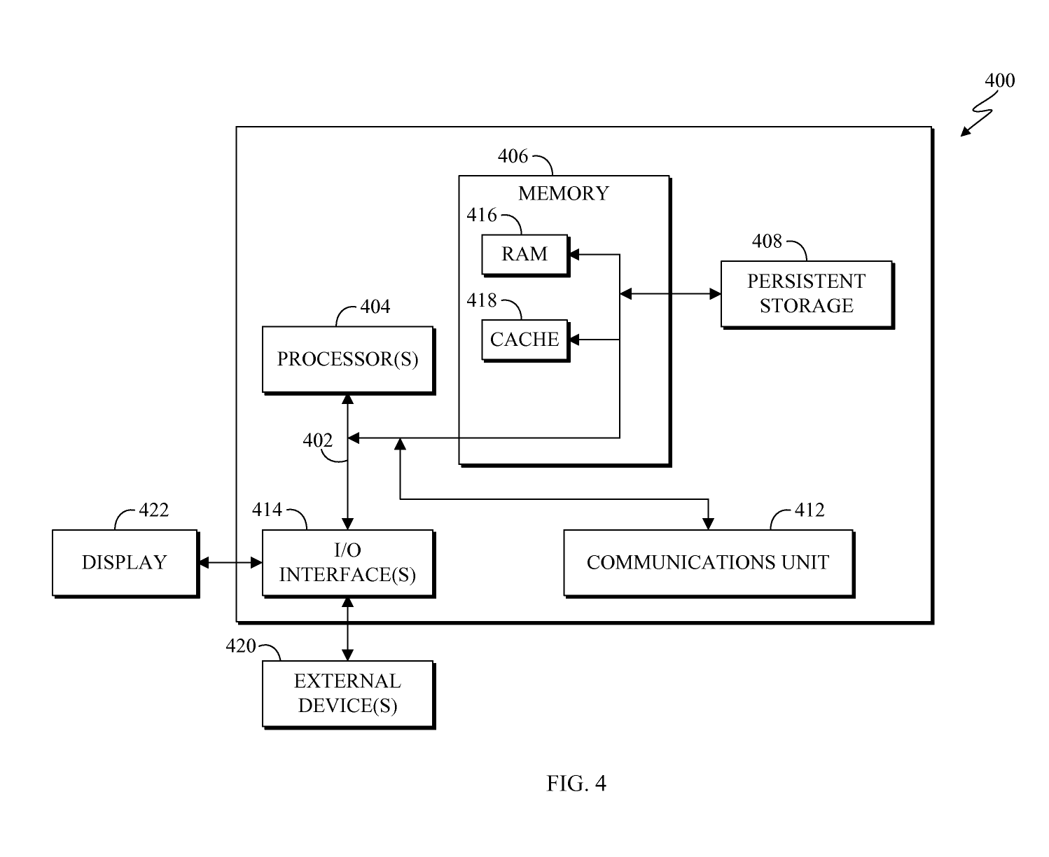

FIG. 4 depicts a block diagram of components of computer 400 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
selecting a team of interest comprising a plurality of individuals;
visualizing the team of interest using a graph depicting each individual's skills relevant to a task;
refining the team of interest based on the visualization; and
displaying the refined team of interest.

2. The method of claim 1, wherein refining the team of interest comprises shrinking the team of interest by removing a member.

3. The method of claim 2, further comprising:
calculating a shrinkage score for each member of the team of interest, wherein a shrinkage score is representative of the negative effects of removing a team member from the team; and
removing the team member with the smallest shrinkage score from the team of interest.

4. The method of claim 1, wherein refining the team of interest comprises recommending enhancing the expertise of a given team member.

5. The method of claim 1, wherein refining the team of interest comprises expanding the team to include an individual from the network not previously on the team of interest.

6. The method of claim 1, wherein refining the team of interest comprises replacing an existing team member with an individual from within the network who is not currently on the team of interest and who has a desired skillset.

7. The method of claim 1, wherein visualizing the team of interest further comprises:
creating a graph of the current members of the team of interest depicting each individual's skills relevant to the team of interest;
refining the team of interest based on the created graph; and
creating a graph of the refined team.

8. The method of claim 7, further comprising:
computing a graph kernel between the graph of the current members of the team of interest and the graph of the refined team.

9. A computer program product comprising:
one or more computer readable storage media and program instructions stored on the one or more computer readable storage media, the program instructions comprising instructions to:
select a team of interest comprising a plurality of individuals;
visualize the team of interest using a graph depicting each individual's skills relevant to a task;
refine the team of interest based on the visualization; and
display the refined team of interest.

10. The computer program product of claim 9, wherein the program instructions to refine the team of interest comprise instructions to shrink the team of interest by removing a member.

11. The computer program product of claim 10, further comprising instructions to:
calculate a shrinkage score for each member of the team of interest, wherein a shrinkage score is representative of the negative effects of removing a team member from the team; and
remove the team member with the smallest shrinkage score from the team of interest.

12. The computer program product of claim 9, wherein program instructions to refine the team of interest comprise instructions to expand the team to include an individual from the network not previously on the team of interest.

13. The computer program product of claim 9, wherein program instructions to visualize the team of interest further comprise instructions to:
create a graph of the current members of the team of interest depicting each individual's skills relevant to the team of interest;
refine the team of interest based on the created graph; and
create a graph of the refined team.

14. The computer program product of claim 13, further comprising program instructions to:
compute a graph kernel between the graph of the current members of the team of interest and the graph of the refined team.

15. A computer system comprising:
one or more computer processors;
one or more computer-readable storage media;
program instructions stored on the computer-readable storage media for execution by at least one of the one or more processors, the program instructions comprising instructions to:
select a team of interest comprising a plurality of individuals;
visualize the team of interest using a graph depicting each individual's skills relevant to a task;
refine the team of interest based on the visualization; and
display the refined team of interest.

16. The computer system of claim 15, wherein the program instructions to refine the team of interest comprise instructions to shrink the team of interest by removing a member.

17. The computer system of claim 16, further comprising instructions to:
calculate a shrinkage score for each member of the team of interest, wherein a shrinkage score is representative of the negative effects of removing a team member from the team; and
remove the team member with the smallest shrinkage score from the team of interest.

18. The computer system of claim 15, wherein program instructions to refine the team of interest comprise instructions to expand the team to include an individual from the network not previously on the team of interest.

19. The computer system of claim 15, wherein program instructions to visualize the team of interest further comprise instructions to:
create a graph of the current members of the team of interest depicting each individual's skills relevant to the team of interest;
refine the team of interest based on the created graph; and
create a graph of the refined team.

20. The computer system of claim 19, further comprising program instructions to:
compute a graph kernel between the graph of the current members of the team of interest and the graph of the refined team.
